(19) United States
(12) Patent Application Publication
(10) Pub. No.: US 2025/0315920 A1
(43) Pub. Date: Oct. 9, 2025

(54) PROBABILITY MODELING-ORIENTED HIGH-PARALLEL AUTOREGRESSIVE SCANNING AND MASKED CONVOLUTION DESIGN METHOD AND SYSTEM

(71) Applicant: Harbin Institute of Technology, Harbin (CN)

(72) Inventors: Xianming Liu, Harbin (CN); Yuanchao Bai, Harbin (CN); Kai Wang, Harbin (CN); Deming Zhai, Harbin (CN); Xiangyang Ji, Harbin (CN)

(21) Appl. No.: 19/172,457

(22) Filed: Apr. 7, 2025

(30) Foreign Application Priority Data
Apr. 7, 2024 (CN) 202410404385.1

(51) Int. Cl. G06T 5/20; G06T 11/20; G06V 10/44; H04N 19/91

(52) U.S. Cl. CPC G06T 5/20; G06T 11/203; G06V 10/44; H04N 19/91; G06T 2207/20076; G06T 2207/20081

(57) ABSTRACT

A probability modeling-oriented high-parallel autoregressive scanning and masked convolution design method is provided. The method includes establishing a mathematical relationship between a number of scanning and an image resolution when the number of scanning and the image resolution exhibit a linear relationship; and constructing a specific scanning angle to meet a limit of a given number of scanning. The method also includes constructing a mask mode of masked convolution under the specific scanning angle. Compared with wavefront scanning, the number of scanning of the scanning mode according to the method is not related to the size of the convolution kernel, but related to the mask mode, so that the larger convolution kernel can be used to enhance the probability estimation performance of the model under the condition that the number of scanning is unchanged.

### CROSS-REFERENCE TO RELATED APPLICATION

This patent application claims the benefit and priority of Chinese Patent Application No. 202410404385.1 filed with the China National Intellectual Property Administration on Apr. 7, 2024, the disclosure of which is incorporated by reference herein in its entirety.

### TECHNICAL FIELD

This application relates to a computer convolution algorithm used in digital image processing, and in particular, relates to a probability modeling-oriented high-parallel autoregressive scanning and masked convolution design method and system.

### BACKGROUND

In the field of modern digital image processing, an autoregressive model has become an indispensable tool, which plays an important role in image generation and image compression. For image generation, the autoregressive model can generate new and realistic images by learning the potential distribution of image data, which is widely used in the fields such as computer vision and graphic design. In the field of image compression, the autoregressive model is used to model the probability distribution of images, which can achieve efficient data representation, thus reducing the data amount required for storing or transmitting images. This is particularly important for optimizing the network bandwidth and the storage resources. The prior art is summarized as follows.

### 1. Serial Scanning Strategy

FIG. 1A is a schematic diagram of serial scanning, in which the total number of scanning=H×W=81. As shown in FIG. 1A, serial scanning is the most commonly used scanning strategy for the autoregressive model, that is, the probability distribution of each point is predicted point by point. The number of scanning steps required is H×W, so that it is difficult for serial scanning to be applied to large-resolution images.

### 2. Wavefront (Topological Order) Scanning Strategy

FIG. 1B is schematic diagram of wave front (topological order) scanning, in which

$$the total number of scanning = ( ⌊ \frac{K}{2} ⌋ + 1 ) ( H - 1 ) + W = 41.$$

Serial scanning does not take into account the parallelism in the scanning process. As shown in FIG. 1B, the current convolution kernel is modeling for the pixel point scanned for the 21st time. All the pixel points shown as 21 that the diagonal line passes through in the figure are capable of being modelled in parallel, because there is no conflict between the contexts. The pixel points in a valid receptive field of the convolution kernel corresponding to each pixel are the decoded pixel points. The relationship between the number of scanning S of wavefront scanning and the size of the convolution kernel K and the image size H×W is as follows:

$$S = ( ⌊ \frac{K}{2} ⌋ + 1 ) ( H - 1 ) + W , \qquad ( 2 - 1 ) .$$

The size of the convolution kernel K is odd. A larger convolution kernel can capture more local information, which will significantly affect the accuracy of probabilistic modeling. However, from the above formula, it can be seen that the number of scanning of wavefront scanning, the size of the convolution kernel and the image size are in a linear relationship. With the increase of the convolution kernel, the number of scanning of wavefront scanning is increased quickly, significantly reducing the parallelism of the model.

### 3. Diagonal Scanning Strategy

FIG. 1C is a schematic diagram of diagonal scanning, in which the total number of scanning=H+W−1=17. The diagonal scanning scheme can further increase the parallelism of the autoregressive model. As shown in FIG. 1C, the receptive field of the convolution kernel is changed, so that the relationship between the number of scanning S of diagonal scanning and the image size is as follows:

$$S = H + W - 1 , \qquad ( 2 - 2 ) .$$

The number of scanning is no longer affected by the size of the convolution kernel, but the performance of the diagonal scanning scheme is limited because the valid receptive field of the convolution kernel of this scheme is concentrated in the upper left part.

### 4. Checkerboard Scanning Strategy

FIG. 1D is a schematic diagram of checkerboard scanning, in which the total number of scanning=2. In lossy image compression, some work has utilized the checkerboard strategy to modify the mask mode of the convolution kernel, replacing the mask mode in the serial scanning scheme, which has significantly improved the encoding and decoding speed of the entropy model. As shown in FIG. 1D, through the checkerboard-like convolution kernel mask mode, all positions can be modeled by scanning only twice, in which the position of the first scan has no context, and the position of the second scan takes the position of the first scan as the context. For lossy compression, checkerboard scanning is usually applied to a feature domain. The spatial correlation of the feature has been decoupled by nonlinear transformation, and the performance degradation brought by checkerboard scanning is relatively small. However, half of the positions lack the context, and such a scanning mode is directly applied to the pixel domain, such as image lossless compression or image generation tasks, resulting in serious performance degradation.

The above-mentioned parallel scanning schemes can only make a trade-off between performance and parallelism, failing to achieve a good balance, and thus being unable to ensure outstanding performance under a higher parallelism.

### SUMMARY

Thus, it would be desirable to provide a probability modeling-oriented high-parallel autoregressive scanning and masked convolution design method and system.

The present disclosure relates to a probability modeling-oriented high-parallel autoregressive scanning and masked convolution design method. The method first gives the definition of a parallel scanning sequence, and achieves a better balance between high parallelism and high performance in combination with the masked convolution design under different scanning sequences. The method includes the following steps:
step S1: establishing a mathematical relationship between the number of scanning and the image resolution of an image when the number of scanning and the image resolution exhibit a linear relationship;
step S2: constructing a specific scanning angle to meet the limit of the given number of scanning;
step S3: constructing a mask mode of masked convolution under the specific scanning angle;
step S4: obtaining a probability distribution of pixel points through a single inference, and training a network by using a cross entropy; and
step S5: determining parallel pixel points corresponding to the number of scanning steps quickly through an advanced indexing, and predicting a probability distribution of the parallel pixel points.

Further, Step S1 includes the following specific steps.

It is assumed that a given image resolution of the image is H×W, W+1 scanning modes linearly related to the resolution and the corresponding number of scanning are designed. A relationship between the number of scanning S_{T} and the resolution is as follows:

$${S}_{T} = T \times ( H - 1 ) + W , T = 0 , 1 , … , W , \qquad ( 3 - 1 )$$

where T is an adjustable parameter for controlling the number of scanning, and W≤S_{T}≤HW is obtained from the formula.

Further, Step S2 includes the following specific steps.

In order to realize the scanning mode corresponding to the specific S_{T}, parallel scanning is performed according to the corresponding scanning angle D_{T}. The corresponding relationship between the scanning angle and the scanning mode is as follows:

$${D}_{T} = \frac{180}{π} \cdot arctan ( \frac{1}{T} ) , T = 0 , 1 , … , W . \qquad ( 3 - 2 )$$

After the scanning angle is obtained, the pixel points, through which a straight line at the scanning angle passes, are pixel points that are capable of parallel modeling. When T=W, a straight line at a scanning angle under T=W only passes through one pixel point at a time, as called serial scanning. Each scanning angle has a corresponding context range; considering a demand of giving consideration to both performance and parallelism, among W+1 scanning angles, a scanning mode under the condition of 1<T≤4 has a larger context range while the number of scanning is close to diagonal scanning (T=1). In autoregressive models, the context range refers to the set of pixels already scanned by the model, typically following a predefined order. The model utilizes this context, consisting of previously scanned pixels, to predict the conditional probability distribution of the current pixel.

Further, Step S3 includes the following specific steps.

The scanning angle D_{T} is given, which determines a scanning sequence of pixel points, in which when a masked convolution is used to capture information of preceding nodes, the specific mask mode is as follows:
Step S31: constructing a mask map with a size equivalent to that of a convolution kernel;
Step S32: in the mask map, drawing a straight line with an angle of D_{T} starting from a modeling point for convolution;
Step S33: setting an area above the straight line in the mask map as a valid context with a corresponding mask value of 1;
Step S34: setting areas where the straight line passes through and below the straight line in the mask map as invalid areas, with a mask value of 0;
Step S35: obtaining the final masked convolution by performing Hadamard product between the convolution kernel and the mask map.

Further, step S4 includes the following specific steps:
determining the scanning angle and the corresponding masked convolution first, extracting features through the masked convolution, obtaining parameters of the probability model of all pixel points through a single inference through a parameter prediction network consisted of 1×1 convolution, and thereafter, training the network through minimizing a loss of the cross entropy based on the predicted probability distribution.

Further, step S5 includes the following specific steps:
determining a scanning sequence and the total number of scanning steps of each pixel point according to the scanning angle first; traversing the number of scanning steps circularly, to extract all parallel scanning pixel points corresponding to the current number of scanning steps through an advanced indexing of torch. tensor in the pytorch tool, and obtaining the parameters of the probability model of the current parallel scanning points through the masked convolution and the parameter prediction network; and performing at least one of lossless compression on the image based on the probability distribution using an entropy codec, and new image generation through a random sampling according to the probability distribution.

The present disclosure further relates to a probability modeling-oriented high-parallel autoregressive scanning and masked convolution design system, including a computer module for performing the probability modeling-oriented high-parallel autoregressive scanning and masked convolution design method.

The present disclosure further relates to a computer device, including a memory and a processor. A computer program is stored in the memory, and the processor, when executing the computer program, implements the steps of the above method.

The present disclosure further relates to a non-transitory computer-readable storage medium having a computer program stored thereon. The computer program, when executed by a processor, implements the steps of the above method.

### Beneficial Effects

1. Compared with serial scanning, the scanning mode according to the present disclosure greatly improves parallelism of the model, and achieves performance similar to that of serial scanning.

2. Compared with wavefront scanning, the number of scanning of the scanning mode according to the present disclosure is no longer related to the size of the convolution kernel, so that the larger convolution kernel can be used to enhance the probability estimation performance of the model under the condition that the number of scanning is unchanged.

3. Compared with diagonal scanning, the scanning mode according to the present disclosure can obtain more valid receptive fields, and improve the performance of the model while slightly increasing the number of scanning.

### BRIEF DESCRIPTION OF THE DRAWINGS

Further features and advantages of the invention arise from the subsequent description, in the exemplary embodiments explained in greater detail by way of the schematic drawings.

FIG. 1A is a diagram of scanning of 9×9 images under one of the existing different masked convolutions in the prior art, in which the number represents the number of scanning steps of the current pixel points-specifically, FIG. 1A shows a serial scanning strategy.

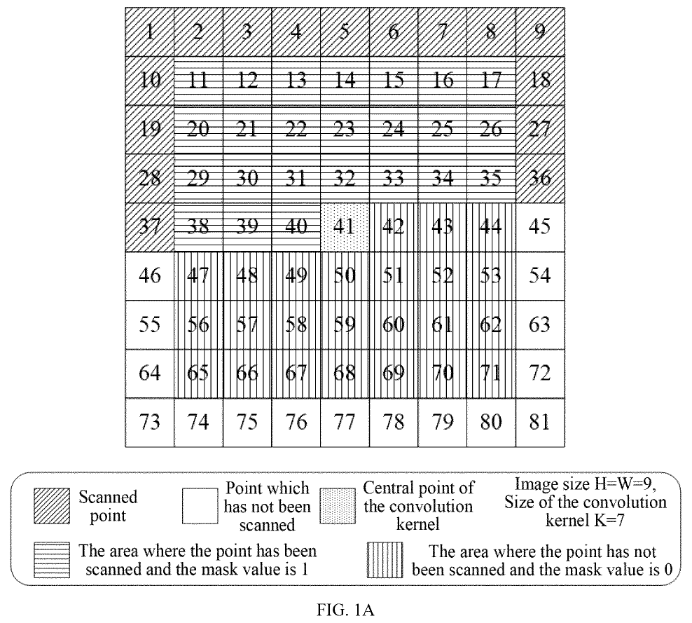

FIG. 1B is a diagram of existing scanning specifically in the form of wavefront (topological order) scanning.

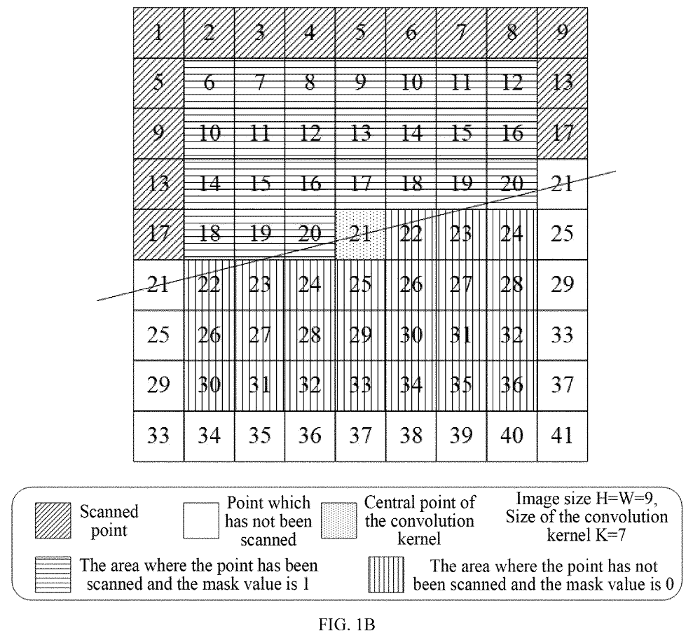

FIG. 1C is a diagram of existing scanning specifically in the form of diagonal scanning.

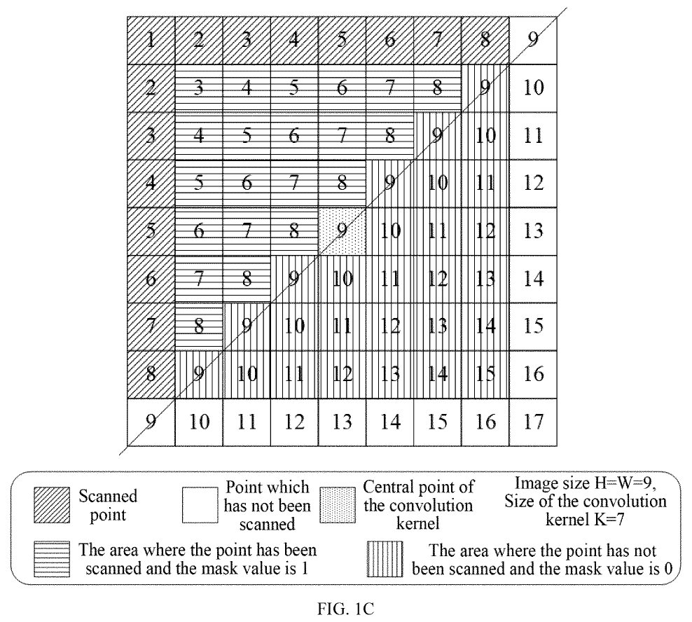

FIG. 1D is a diagram of existing scanning specifically in the form of checkerboard scanning.

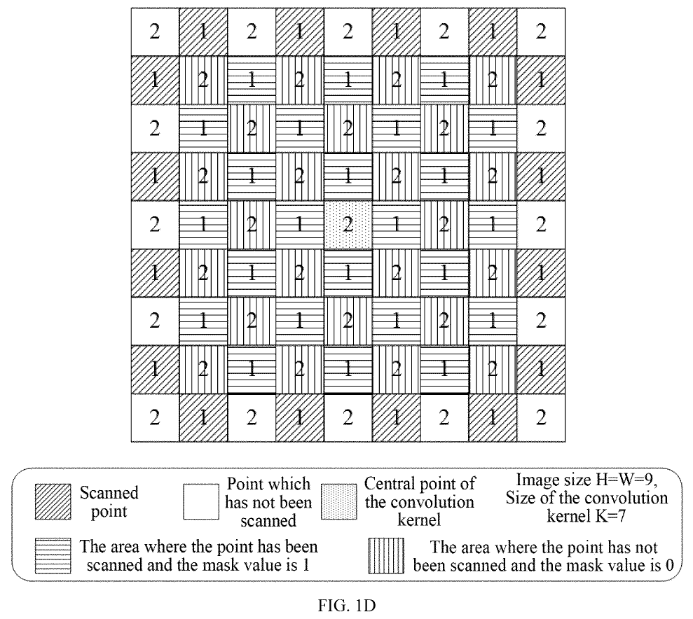

FIG. 2A is a schematic diagram of scanning, the image resolution and the corresponding mask mode according to embodiments of the present disclosure, in which the number represents the number of scanning steps of the current pixel points, and D₂ represents the scanning angle.

FIG. 2B is a schematic diagram of scanning according to the embodiments of the present disclosure, with a higher scanning angle than in FIG. 2A.

FIG. 2C is a schematic diagram of scanning according to the embodiments of the present disclosure, with a higher scanning angle than in FIG. 2B.

FIG. 2D is a schematic diagram of scanning according to the embodiments of the present disclosure, with a higher scanning angle than in FIG. 2C.

FIG. 2E is a schematic diagram of scanning according to the embodiments of the present disclosure, with a higher scanning angle than in FIG. 2D

### DETAILED DESCRIPTION

The present embodiment will be described in detail with reference to the attached drawings.

The probability modeling-oriented high-parallel autoregressive scanning and masked convolution design method of the present disclosure includes steps S1-S5.

In step S1, a mathematical relationship between the number of scanning and the image resolution of an image is established when the number of scanning and the image resolution exhibit a linear relationship.

It is assumed that a given image resolution of the image is H×W, W+1 scanning modes linearly related to the resolution and the corresponding number of scanning are designed. The relationship between the number of scanning S_{T} and the resolution is as follows:

$${S}_{T} = T \times ( H - 1 ) + W , T = 0 , 1 , … , W , \qquad ( 3 - 1 )$$

where T is an adjustable parameter for controlling the number of scanning, and W≤S_{T}≤HW is obtained from the formula.

In step S2, a specific scanning angle is constructed to meet the limit of the given number of scanning.

In order to realize the scanning mode corresponding to the specific S_{T}, parallel scanning is performed according to the corresponding scanning angle D_{T} (the included angle with the horizontal line), in which the corresponding relationship between the scanning angle and the scanning mode is as follows:

$${D}_{T} = \frac{180}{π} \cdot arctan ( \frac{1}{T} ) , T = 0 , 1 , … , W . \qquad ( 3 - 2 )$$

After the scanning angle is obtained, the pixel points, through which a straight line at the angle passes, are pixel points that are capable of being modelled in parallel. When T=W, the straight line at the angle only passes through one pixel point at a time, which is called serial scanning. Each scanning angle has a corresponding context range (i.e. a preceding node). Considering the need to give consideration to both the performance and the parallelism, among the W+1 scanning angles, the scanning mode under the condition of 1<T≤4 has a larger context range while the number of scanning is close to the diagonal scanning (T=1).

In step S3, a mask mode of masked convolution under a specific scanning angle is constructed.

The scanning angle D_{T} is given, which determines a scanning sequence of pixel points. When the masked convolution is used to capture the information of the preceding nodes, the specific mask mode is as follows, which includes steps S31-S35.

In step S31, a mask map is constructed, the size of which is equivalent to that of a convolution kernel.

In step S32, in the mask map, a straight line with an angle of D_{T} starting from a convolution modeling point is drawn.

In step S33, the area above the straight line in the mask map is a valid context, and the corresponding mask value is 1.

In step S34, the areas where the straight line passes through and below the straight line in the mask map are invalid areas, and the corresponding mask value is 0;

In step S35, the final masked convolution is obtained by performing Hadamard product (element-wise multiplication) between the convolution kernel and the mask map.

In step S4, parallel training is processed.

The probability distribution of pixel points is obtained through a single inference, and the network is trained by using the cross entropy.

Through the above steps, the scanning angle and the mask mode of the corresponding convolution kernel are determined. In practical application, for scenarios with low real-time requirements, a larger scanning sequence and a larger masked convolution can be used to improve the performance of the model. For scenarios with high real-time requirements, a smaller scanning angle can be adopted, along with limiting the size of the masked convolution kernel. After features are extracted through the masked convolution, parameters of the probability model can be predicted through a parameter prediction network, such as a Gaussian model or a Logistic model. The network is trained by minimizing the cross entropy loss based on the predicted probability distribution. The parameter prediction network consists of several 1×1 convolution layers. On the one hand, 1×1 convolution can ensure that the receptive field is not leaked and the information of subsequent nodes is not captured. On the other hand, 1×1 convolution has fewer parameters and in turn less calculation, which is beneficial to improve the running speed of the model. The above design can ensure that the probability distribution of all points can be obtained only through a single inference during the training, which makes full use of the parallel computing ability of the Graphics Processing Unit (GPU).

In step S5, testing is processed by performing actual scanning samples, e.g., conducting a parallel scanning sequence with scanning equipment used for image processing tasks.

A scanning sequence and the total number of scanning steps of each pixel point are determined according to the scanning angle first. Thereafter, the number of scanning steps is traversed circularly, so that all parallel scanning pixel points corresponding to the current number of scanning steps are extracted through an advanced indexing of torch. tensor in the pytorch tool. The parameters of the probability model of the current parallel scanning points are obtained through the masked convolution and the parameter prediction network. After the autoregressive model is trained, on one hand, lossless compression is performed on the image based on the estimated probability by an entropy codec, on the other hand, a new image is generated through random sampling according to the estimated probability.

### Embodiment

The embodiment of the present disclosure will be described with specific examples hereinafter.

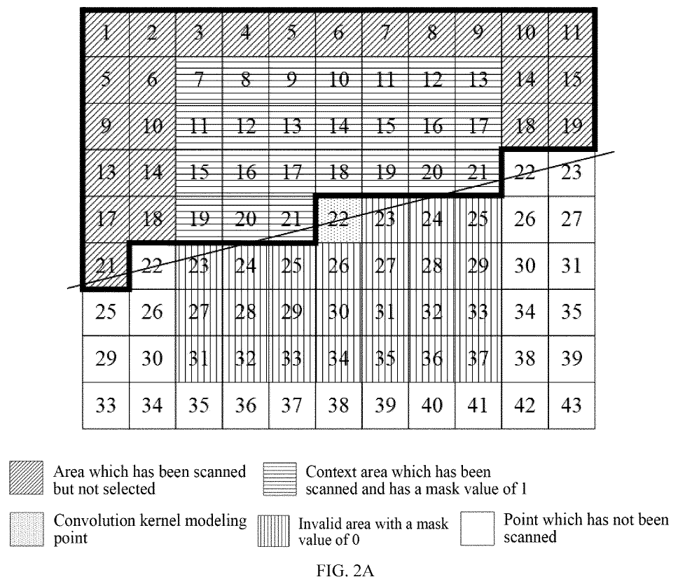

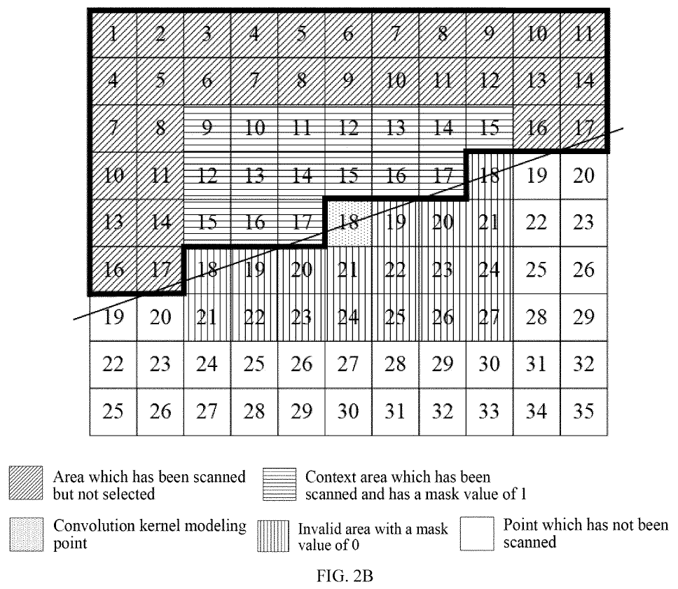

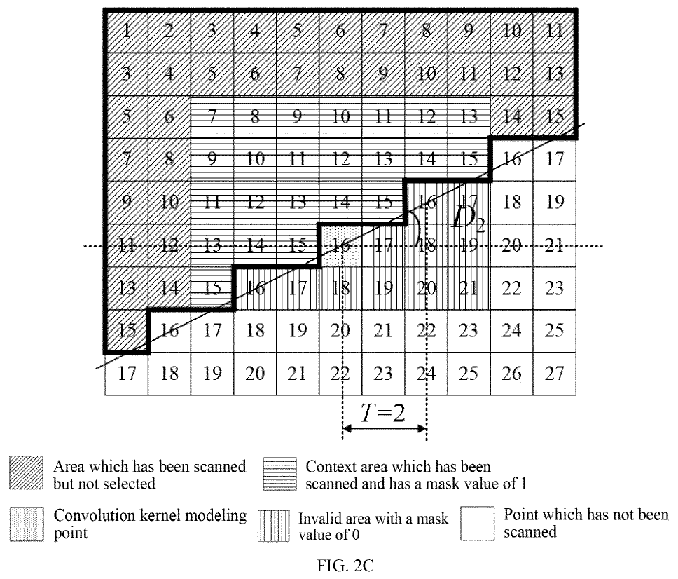

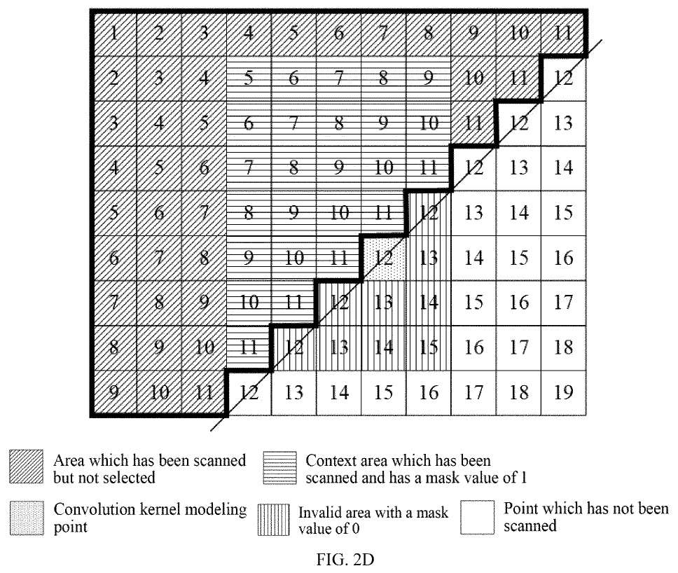

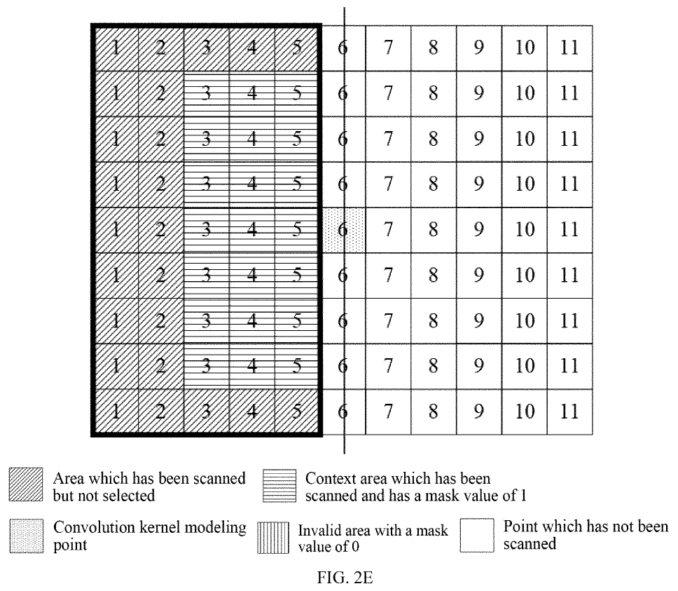

Taking a 9×11 image as an example, FIGS. 2A-2E represent the corresponding relationship between the number of scanning steps S_{T} and the scanning angle and the image resolution when T={4, 3, 2, 1, 0}, and the construction mode of the convolution mask map under the number of scanning steps, respectively. Specifically, FIG. 2A is a S4 scanning schematic diagram, in which the total number of scanning=4 (H−1)+W=43; FIG. 2B is a S₃ scanning schematic diagram, in which the total number of scanning=3 (H−1)+W=35; FIG. 2C is a S₂ scanning schematic diagram, in which the total number of scanning=2 (H−1)+W=27; FIG. 2D is a S₁ scanning schematic diagram, in which the total number of scanning=(H−1)+W=19; FIG. 2E is a S₀ scanning schematic diagram, in which the total number of scanning=W=11. The image size is H=9 and W=11. All currently visible contexts in the bold black box.

The area enclosed by the bold black line in the figure represents the area in the image that have been scanned when the modeling point of the convolution kernel is the dot-filled part. The area outside the area enclosed by the bold black line is an area to be scanned. The area with 45-degree hatching includes pixel points that has been scanned, but not selected by the convolution kernel. The part with 0-degree hatching is the area that has been scanned and the mask value is 1. The dot-filled part is the modeling point of the current convolution kernel. The part with 90-degree hatching is the invalid area with a mask value of 0. The white part includes the points which have not been scanned and have not been modeled.

FIG. 2C shows the corresponding relationship between the number of scanning steps and the scanning angle. The included angle formed by the black line and the horizontal line in the figure is the scanning angle D₂ corresponding to the current S₂, and the scanning angles D_{T} of other images are not drawn repeatedly any longer.

The number in FIGS. 2A-2E indicates the number of scanning steps of the pixel point. The pixel points with the same number are the pixel points scanned in parallel. The pixel point in the lower-right corner is the last scanned pixel point and its corresponding number is S_{T}. As it can be seen from the number of scanning steps in FIGS. 2A-2E, when T is decreased, the scanning angle D_{T} is gradually increased, and the number of scanning steps S_{T} of the corresponding image is gradually decreased.

The scanning angle of FIG. 2A is minimal. The corresponding number of scanning steps S_{T}=43 is maximal among five sub-diagrams. In FIGS. 2B-2E, the scanning angle is gradually increased, and thus the number of scanning steps are reduced, and the number of valid contexts is reduced. Therefore, it is necessary to modify the mask map to cover more context areas, so as to ensure that the receptive field is not leaked in the scanning process.

The total number of scanning steps in FIG. 2C is calculated as S₂=2 (H−1)+W=27, which shows a good trade-off between the number of scanning steps and the number of valid contexts, and can save 40% of the number of scanning steps under the condition of similar performance to that of S₄ scanning mode.

The scanning angles in FIG. 2D and FIG. 2E are further increased, but the number of valid contexts is too small, which limits the modeling ability of the model under the scanning sequence.

The area enclosed by the bold black line is the corresponding visible area under each scanning sequence, and any selected combination in the area enclosed by the bold black line is a legal context combination.

The present disclosure utilizes the masked convolution to capture the context of the visible area. The shape of the convolution kernel is no longer restricted to a square. The modeling point of the convolution kernel is no longer limited to the central point of the convolution kernel. It is only necessary to construct the masked convolution according to the mask construction method given above to ensure that the masked convolution does not capture the information of subsequent nodes which have not been scanned.

Now described is one example environment in which the systems and/or methods described herein may be implemented. The environment may include a user device, a records management platform supported within a cloud computing environment, and/or a network. Devices of environment may interconnect via wired connections, wireless connections, or a combination of wired and wireless connections.

User device includes one or more devices capable of receiving, generating, storing, processing, and/or providing information associated with autoregressive scanning. For example, user device may include a device, such as a tablet computer (e.g., an iPad, etc.), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device.

In some embodiments, the user device may communicate with the records management platform using a communication interface. In some embodiments, the user device may submit a request to the records management platform. For example, the user device may submit a request for a scan result. In some embodiments, to assist the records management platform in satisfying the request, the user device may provide the records management platform with historical data.

Records management platform includes one or more devices capable of receiving, storing, processing, and/or providing information associated with autoregressive scanning used in image processing applications. For example, records management platform may include a server device (e.g., a host server, a web server, an application server, etc.), a data center device, or a similar device. In some embodiments, the records management platform may have access to a database and/or data structure used to sort, organize, and filter one or more types of data described herein. In some embodiments, the database and/or data structure may be local to the records management platform. In some embodiments, the database and/or data structure may be a third-party storage provider. In some embodiments, the records management platform may train a data model using machine learning. The data model may be used to make classifications, predictions, and/or recommendations in accordance with the principles of the present disclosure. In some embodiments, the data model may be trained by an external device or server and the trained data model may be provided to or made accessible to the records management.

In some embodiments, as shown, the records management platform may be hosted in the cloud computing environment. Notably, while embodiments described herein describe the records management platform as being hosted in the cloud computing environment, in some embodiments, the records management platform may not be cloud-based (i.e., may be implemented outside of a cloud computing environment) or may be partially cloud-based.

Cloud computing environment includes an environment that hosts records management platform. Cloud computing environment may provide computation, software, data access, storage, etc. services that do not require end-user knowledge of a physical location and configuration of system(s) and/or device(s) that hosts the records management platform. As shown, the cloud computing environment may include a group of computing resources (referred to collectively as “computing resources” and individually as “computing resource”).

Computing resource includes one or more personal computers, workstation computers, server devices, or another type of computation and/or communication device. In some embodiments, the computing resource may host the records management platform. The cloud resources may include compute instances executing in the computing resource, storage devices provided in the computing resource, data transfer devices provided by the computing resource, and/or the like. In some embodiments, the computing resource may communicate with other computing resources via wired connections, wireless connections, or a combination of wired and wireless connections.

The computing resource may include a group of cloud resources, such as one or more applications (“APPs”), one or more virtual machines (“VMs”), virtualized storage (“VSs”), one or more hypervisors (“HYPs”), and/or the like.

Application may include one or more software applications that may be provided to or accessed by user device. Application may eliminate a need to install and execute the software applications on these devices. In some embodiments, one application may send/receive information to/from one or more other applications, via virtual machine. In some embodiments, application may be a scanning application. In some embodiments, the scanning application may include one or more user interfaces that are accessible by users.

Virtual machine may include a software implementation of a machine (e.g., a computer) that executes programs like a physical machine. Virtual machine may be either a system virtual machine or a process virtual machine, depending upon use and degree of correspondence to any real machine by virtual machine. A system virtual machine may provide a complete system platform that supports execution of a complete operating system (“OS”). A process virtual machine may execute a single program and may support a single process. In some embodiments, virtual machine may execute on behalf of another device (e.g., user device), and may manage infrastructure of the cloud computing environment, such as data management, synchronization, or long-duration data transfers.

Virtualized storage may include one or more storage systems and/or one or more devices that use virtualization techniques within the storage systems or devices of the computing resource. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor may provide hardware virtualization techniques that allow multiple operating systems (e.g., “guest operating systems”) to execute concurrently on a host computer, such as computing resource. Hypervisor may present a virtual operating platform to the guest operating systems and may manage the execution of the guest operating systems.

Network includes one or more wired and/or wireless networks. For example, network may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks are provided as an example. In practice, there may be additional devices and/or networks, fewer devices and/or networks, different devices and/or networks, or differently arranged devices and/or networks than those described. Furthermore, two or more devices may be implemented within a single device, or a single device may be implemented as multiple, distributed devices. Additionally, or alternatively, a set of devices (e.g., one or more devices) of environment may perform one or more functions described as being performed by another set of devices of environment.

Now described is an exemplary device for performing the autoregressive scanning. Device may correspond to the user device and/or the records management platform. In some embodiments, the user device and/or the records management platform may include one or more devices and/or one or more components of device. Device may include a bus, a processor, a memory, a storage component, an input component, an output component, and/or a communication interface. Further, the device may include a scanning equipment to provide inputs for image processing and for training and testing the model identified herein.

Bus includes a component that permits communication among multiple components of device. Processor is implemented in hardware, firmware, and/or a combination of hardware and software. Processor includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some embodiments, processor includes one or more processors capable of being programmed to perform a function. Memory includes a random-access memory (RAM), a read only memory (ROM), and/or another type of dynamic or static storage device (e.g., a flash memory, a magnetic memory, and/or an optical memory) that stores information and/or instructions for use by processor.

Storage component stores information and/or software related to the operation and use of device. For example, storage component may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component includes a component that permits device to receive information, such as via user input (e.g., a touch screen display, a keyboard, a keypad, a mouse, a button, a switch, and/or a microphone). Additionally, or alternatively, input component may include a sensor for sensing information (e.g., a global positioning system (GPS) component, an accelerometer, a gyroscope, and/or an actuator). Output component includes a component that provides output information from device (e.g., a display, a speaker, and/or one or more light-emitting diodes (LEDs)).

Communication interface includes a transceiver-like component (e.g., a transceiver and/or a separate receiver and transmitter) that enables device to communicate with other devices, such as via a wired connection, a wireless connection, or a combination of wired and wireless connections. Communication interface may permit device to receive information from another device and/or provide information to another device. For example, communication interface may include an Ethernet interface, an optical interface, a coaxial interface, an infrared interface, a radio frequency (RF) interface, a universal serial bus (USB) interface, a Wi-Fi interface, a cellular network interface, an application programming interface (API), and/or the like.

Device may perform one or more processes described herein. Device may perform these processes based on processor executing software instructions stored by a non-transitory computer-readable medium, such as memory and/or storage component, the processor being connected to scanning equipment as noted previously so that a parallel scanning sequence can be performed to train or test a model for image processing which is to be used in practical contexts such as image generation and image compression. A computer-readable medium is defined herein as a non-transitory memory device. A memory device includes memory space within a single physical storage device or memory space spread across multiple physical storage devices.

Software instructions may be read into memory and/or storage component from another computer-readable medium or from another device via communication interface. When executed, software instructions stored in memory and/or storage component may cause processor to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components described in the prior paragraphs are provided as an example. In practice, device may include additional components, fewer components, different components, or differently arranged components than those described. Additionally, or alternatively, a set of components (e.g., one or more components) of device may perform one or more functions described as being performed by another set of components of device.

The above contents of the present disclosure are only the preferred embodiments of the present disclosure, rather than limit the implementation of the present disclosure. According to the main concept and spirit of the present disclosure, those skilled in the art can make corresponding adaptations or modifications very conveniently. Therefore, the scope of protection of the present disclosure should be based on the scope of protection required by the claims.

What is claimed is:

1. A probability modeling-oriented parallel autoregressive scanning and masked convolution design method, comprising:
step S1: establishing a mathematical relationship between a number of scanning and an image resolution of an image when the number of scanning and the image resolution exhibit a linear relationship;
step S2: constructing a specific scanning angle to meet a limit of a given number of scanning;
step S3: constructing a mask mode of masked convolution under the specific scanning angle;
step S4: obtaining a probability distribution of pixel points through a single inference, and training a network by using a cross entropy;
step S5: determining parallel pixel points corresponding to a number of scanning steps through an advanced indexing, and predicting a probability distribution of the parallel pixel points.

2. The probability modeling-oriented parallel autoregressive scanning and masked convolution design method according to claim 1, wherein step S1 comprises following steps:
assuming that a given image resolution of the image is H×W, designing W+1 scanning modes linearly related to the image resolution and corresponding number of scanning; a relationship between the number of scanning S_{T} and the image resolution is as follows:
$${S}_{T} = T \times ( H - 1 ) + W , T = 0 , 1 , … , W ,$$
where T is an adjustable parameter configured to control the number of scanning, and W≤S_{T}≤HW is obtained from the formula.

3. The probability modeling-oriented parallel autoregressive scanning and masked convolution design method according to claim 1, wherein step S2 comprises following steps:
performing parallel scanning according to a corresponding scanning angle D_{T} for realizing a scanning mode corresponding to the specific number of scanning S_{T}, a corresponding relationship between the scanning angle and the scanning mode is as follows:
$${D}_{T} = \frac{180}{π} \cdot arctan ( \frac{1}{T} ) , T = 0 , 1 , … , W ,$$
after the scanning angle is obtained, pixel points, through which a straight line at the scanning angle passes, are pixel points that are capable of parallel modeling; when T=W, a straight line at a scanning angle under T=W only passes through one pixel point at a time, which is called serial scanning; each scanning angle has a corresponding context range; considering a demand of giving consideration to both performance and parallelism, among W+1 scanning angles, a scanning mode under a condition of 1<T≤4 has a larger context range while the number of scanning is close to a diagonal scanning (T=1).

4. The probability modeling-oriented parallel autoregressive scanning and masked convolution design method according to claim 1, wherein step S3 comprises following steps:
giving a scanning angle D_{T}, the scanning angle determining a scanning sequence of pixel points, when the masked convolution is used to capture information of preceding nodes, the mask mode comprising:
step S31: constructing a mask map, with a size equivalent to that of a convolution kernel;
step S32: in the mask map, drawing a straight line with the scanning angle D_{T} starting from a modeling point for convolution;
step S33: setting an area above the straight line in the mask map as a valid context, with a corresponding mask value of 1;
step S34: setting areas where the straight line passes through and below the straight line in the mask map as invalid areas, with a mask value of 0;
step S35: obtain a final masked convolution by preforming Hadamard product between the convolution kernel and the mask map.

5. The probability modeling-oriented parallel autoregressive scanning and masked convolution design method according to claim 1, wherein step S4 comprises following steps:
determining the scanning angle and a corresponding masked convolution;
extracting features through the masked convolution;
obtaining parameters of a probability model of all pixel points through the single inference by a parameter prediction network consisted of 1×1 convolution; and
training the network through minimizing a loss of the cross entropy based on the predicted probability distribution.

6. The probability modeling-oriented parallel autoregressive scanning and masked convolution design method according to claim 1, wherein step S5 comprises following steps:
determining a scanning sequence and a total number of scanning steps of each pixel point according to the scanning angle;
traversing the number of scanning steps circularly, to extract all parallel scanning pixel points corresponding to a current number of scanning steps through the advanced indexing;
obtaining parameters of a probability model of current parallel scanning points through the masked convolution and a parameter prediction network; and
performing at least one of lossless compression on the image based on the probability distribution using an entropy codec, and new image generation through a random sampling according to the probability distribution.

7. A probability modeling-oriented parallel autoregressive scanning and masked convolution design system, comprising a memory storing a computer program and a processor, wherein the processor, when executing the computer program, implements the probability modeling-oriented parallel autoregressive scanning and masked convolution design method according to claim 1.

8. The probability modeling-oriented parallel autoregressive scanning and masked convolution design system according to claim 7, wherein step S1 comprises following steps:
assuming that a given image resolution of the image is H×W, designing W+1 scanning modes linearly related to the image resolution and corresponding number of scanning; a relationship between the number of scanning S_{T} and the image resolution is as follows:
$${S}_{T} = T \times ( H - 1 ) + W , T = 0 , 1 , … , W ,$$
where T is an adjustable parameter configured to control the number of scanning, and W≤S_{T}≤HW is obtained from the formula.

9. The probability modeling-oriented parallel autoregressive scanning and masked convolution design system according to claim 7, wherein step S2 comprises following steps:
performing parallel scanning according to a corresponding scanning angle D_{T} for realizing a scanning mode corresponding to the specific number of scanning S_{T}, a corresponding relationship between the scanning angle and the scanning mode is as follows:
$${D}_{T} = \frac{180}{π} \cdot arctan ( \frac{1}{T} ) , T = 0 , 1 , … , W ,$$
after the scanning angle is obtained, pixel points, through which a straight line at the scanning angle passes, are pixel points that are capable of parallel modeling; when T=W, a straight line at a scanning angle under T=W only passes through one pixel point at a time, which is called serial scanning; each scanning angle has a corresponding context range; considering a demand of giving consideration to both performance and parallelism, among W+1 scanning angles, a scanning mode under a condition of 1<T≤4 has a larger context range while the number of scanning is close to a diagonal scanning (T=1).

10. The probability modeling-oriented parallel autoregressive scanning and masked convolution design system according to claim 7, wherein step S3 comprises following steps:
giving a scanning angle D_{T}, the scanning angle determining a scanning sequence of pixel points, when the masked convolution is used to capture information of preceding nodes, the mask mode comprising:
step S31: constructing a mask map, with a size equivalent to that of a convolution kernel;
step S32: in the mask map, drawing a straight line with the scanning angle D_{T} starting from a modeling point for convolution;
step S33: setting an area above the straight line in the mask map as a valid context, with a corresponding mask value of 1;
step S34: setting areas where the straight line passes through and below the straight line in the mask map as invalid areas, with a mask value of 0;
step S35: obtain a final masked convolution by preforming Hadamard product between the convolution kernel and the mask map.

11. The probability modeling-oriented parallel autoregressive scanning and masked convolution design system according to claim 7, wherein step S4 comprises following steps:
determining the scanning angle and a corresponding masked convolution;
extracting features through the masked convolution;
obtaining parameters of a probability model of all pixel points through the single inference by a parameter prediction network consisted of 1×1 convolution; and
training the network through minimizing a loss of the cross entropy based on the predicted probability distribution.

12. The probability modeling-oriented parallel autoregressive scanning and masked convolution design system according to claim 7, wherein step S5 comprises following steps:
determining a scanning sequence and a total number of scanning steps of each pixel point according to the scanning angle;
traversing the number of scanning steps circularly, to extract all parallel scanning pixel points corresponding to a current number of scanning steps through the advanced indexing;
obtaining parameters of a probability model of current parallel scanning points through the masked convolution and a parameter prediction network; and
performing at least one of lossless compression on the image based on the probability distribution using an entropy codec, and new image generation through a random sampling according to the probability distribution.

13. A non-transitory computer-readable storage medium having a computer program stored thereon, wherein the computer program, when executed by a processor, implements the probability modeling-oriented parallel autoregressive scanning and masked convolution design method according to claim 1.

14. The non-transitory computer-readable storage medium according to claim 13, wherein step S1 comprises following steps:
assuming that a given image resolution of the image is H×W, designing W+1 scanning modes linearly related to the image resolution and corresponding number of scanning; a relationship between the number of scanning S_{T} and the image resolution is as follows:
$${S}_{T} = T \times ( H - 1 ) + W , T = 0 , 1 , … , W ,$$
where T is an adjustable parameter configured to control the number of scanning, and W≤S_{T}≤HW is obtained from the formula.

15. The non-transitory computer-readable storage medium according to claim 13, wherein step S2 comprises following steps:
performing parallel scanning according to a corresponding scanning angle D_{T} for realizing a scanning mode corresponding to the specific number of scanning S_{T}, a corresponding relationship between the scanning angle and the scanning mode is as follows:
$${D}_{T} = \frac{180}{π} \cdot arctan ( \frac{1}{T} ) , T = 0 , 1 , … , W ,$$
after the scanning angle is obtained, pixel points, through which a straight line at the scanning angle passes, are pixel points that are capable of parallel modeling; when T=W, a straight line at a scanning angle under T=W only passes through one pixel point at a time, which is called serial scanning; each scanning angle has a corresponding context range; considering a demand of giving consideration to both performance and parallelism, among W+1 scanning angles, a scanning mode under a condition of 1<T≤4 has a larger context range while the number of scanning is close to a diagonal scanning (T=1).

16. The non-transitory computer-readable storage medium according to claim 13, wherein step S3 comprises following steps:
giving a scanning angle D_{T}, the scanning angle determining a scanning sequence of pixel points, when the masked convolution is used to capture information of preceding nodes, the mask mode comprising:
step S31: constructing a mask map, with a size equivalent to that of a convolution kernel;
step S32: in the mask map, drawing a straight line with the scanning angle D_{T} starting from a modeling point for convolution;
step S33: setting an area above the straight line in the mask map as a valid context, with a corresponding mask value of 1;
step S34: setting areas where the straight line passes through and below the straight line in the mask map as invalid areas, with a mask value of 0;
step S35: obtain a final masked convolution by preforming Hadamard product between the convolution kernel and the mask map.

17. The non-transitory computer-readable storage medium according to claim 13, wherein step S4 comprises following steps:
determining the scanning angle and a corresponding masked convolution;
extracting features through the masked convolution;
obtaining parameters of a probability model of all pixel points through the single inference by a parameter prediction network consisted of 1×1 convolution; and
training the network through minimizing a loss of the cross entropy based on the predicted probability distribution.

18. The non-transitory computer-readable storage medium according to claim 13, wherein step S5 comprises following steps:
determining a scanning sequence and a total number of scanning steps of each pixel point according to the scanning angle;
traversing the number of scanning steps circularly, to extract all parallel scanning pixel points corresponding to a current number of scanning steps through the advanced indexing;
obtaining parameters of a probability model of current parallel scanning points through the masked convolution and a parameter prediction network; and
performing at least one of lossless compression on the image based on the probability distribution using an entropy codec, and new image generation through a random sampling according to the probability distribution.

19. The probability modeling-oriented parallel autoregressive scanning and masked convolution design method according to claim 1, wherein the steps S1 through S5 are each performed by a processor connected to a scanning equipment, and the method further includes:
operating the scanning equipment according to a model of autoregressive scanning and masked convolution generated by the processor, to thereby perform a parallel scanning sequence to process an image for further generative or compression storage uses.
